(19) United States
(12) Patent Application Publication
(10) Pub. No.: US 2012/0043209 A1
(43) Pub. Date: Feb. 23, 2012

(54) MICROFLUIDIC CONTROL APPARATUS AND OPERATING METHOD THEREOF

(76) Inventors: Cheng-Hsien Liu, Hsinchu City (TW); William Wang, Taoyuan City (TW); Long Hsu, Hsinchu City (TW); Yuh-Shyong Yang, Hsinchu City (TW); Hwan-You Chang, Hsinchu City (TW); Shih-Mo Yang, Taichung City (TW); Chung-Cheng Chou, Luzhu Township (TW)

(21) Appl. No.: 13/212,596

(22) Filed: Aug. 18, 2011

(30) Foreign Application Priority Data
Aug. 20, 2010 (TW) 099127872

(51) Int. Cl. G01N 27/447; B01D 21/00; G01N 27/453

(52) U.S. Cl. 204/454; 204/601

(57) ABSTRACT

A microfluidic control apparatus and operating method thereof. The microfluidic control apparatus includes a photoconductive material layer and a flow passage. When a light with a specific optical pattern is emitted toward the photoconductive material layer, at least three virtual electrodes are formed on the photoconductive material layer according to the specific optical pattern. The at least three virtual electrodes include a first virtual electrode, a second virtual electrode and a third virtual electrode disposed beside the first virtual electrode. There is a specific proportion among a distance between first virtual electrode and third virtual electrode, a width of first virtual electrode, a distance between first virtual electrode and second virtual electrode, and a width of second virtual electrode. When the specific optical pattern changes, the at least three virtual electrodes also change to generate an electro-osmotic force to control the moving state of a microfluid in a flow passage.

### CROSS-REFERENCE TO RELATED APPLICATION

This application claims priority to Taiwanese Patent Application No. 099127872, filed on Aug. 20, 2010, the disclosure of which is incorporated herein by reference in its entirety

### BACKGROUND OF THE INVENTION

1. Field of the Invention

The invention relates to microfluid control, in particular, to a microfluidic control apparatus and operating method thereof capable of changing the position of the optical pattern to adjust the alignment and forming ratio of virtual electrodes formed on the photoconductive material layer to control the moving state of the microfluid in the flow passage.

2. Description of the Prior Art

In recent years, with the continuous progress of medical technology, the medical equipment is also developed toward the direction of innovation. Therefore, more and more advanced medical equipments have been widely applied in clinical diagnosis and treatment. For example, the medical chips using the microfluidic system can be widely used in various ways including capturing rare type of cells, mixing drug reagents, and controlling small particles.

Among all microfluidic systems used in common medical chips, Electro-Osmotic Flows (EOFs) control the flowing direction of microfluid through disposing electrodes of different sizes. However, when the user practically uses the medical chips, the biggest problem is that under the precondition of fixed frequency of the applied voltage, the flowing direction of the microfluid can be changed; therefore, it is hard for the user to freely adjust or change the flowing direction of the microfluid, and the convenience and flexibility of controlling the microfluid will be seriously limited. It is hard to control the flowing direction of the microfluid, unless the user can continuously change the positions of electrodes of different sizes or the applied voltage and its frequency. However, in fact, these ways are not feasible because it is inconvenient for the user or even generates other influences.

Therefore, the invention provides a microfluidic control apparatus and operating method thereof to solve the above-mentioned problems.

### SUMMARY OF THE INVENTION

A scope of the invention is to provide a microfluidic control apparatus. Different from the Electro-Osmotic Flow (EOF) mechanism used in conventional microfluidic control apparatus, the microfluidic control apparatus of the invention uses the Opto-Electro-Osmotic Flow (OEOF) mechanism to change the position of the optical pattern to adjust the alignment and forming ratio of virtual electrodes formed on the photoconductive material layer to control the moving state of the microfluid in the flow passage.

A first embodiment of the invention is a microfluidic control apparatus. In this embodiment, the microfluidic control apparatus includes a photoconductive material layer and a flow passage. When a light with a specific optical pattern is emitted toward the photoconductive material layer, at least three virtual electrodes are formed on the photoconductive material layer according to the specific optical pattern. The at least three virtual electrodes include a first virtual electrode, a second virtual electrode, and a third virtual electrode. The second virtual electrode and the third virtual electrode are disposed at two sides of the first virtual electrode. A specific ratio is existed among the distance between the first virtual electrode and the third virtual electrode, the width of the first virtual electrode, the distance between the first virtual electrode and the second virtual electrode, and the width of the second virtual electrode. When the specific optical pattern changes, the at least three virtual electrodes also change to generate an electro-osmotic force to control a moving state of a microfluid in the flow passage.

In practical applications, the specific ratio existed among the distance G1 between the first virtual electrode and the third virtual electrode, the width W1 of the first virtual electrode, the distance G2 between the first virtual electrode and the second virtual electrode, and the width W2 of the second virtual electrode can be 1:5:1:3. The photoconductive material layer can be formed by a material having resistance varied with different lights; the photoconductive material layer can be charge generating layer material Titanium Oxide Phthalocyanine (TiOPc), amorphous silicon (a-Si), or polymer.

In this embodiment, an Electro-Osmotic Flow (EOF) mechanism can be used to change the position of the specific optical pattern to adjust a forming ratio of the at least three virtual electrodes formed on the photoconductive material layer to control the microfluid. Under the condition of maintaining the voltage and the frequency unchanged, the microfluidic control apparatus controls a moving direction or a rotation direction of the particles in the microfluid, so that the microfluid forms moving states of driving, mixing, concentrating, separating, and swirl.

A second embodiment of the invention is a microfluidic control apparatus operating method. In this embodiment, the microfluidic control apparatus operating method is applied in a microfluidic control apparatus, and the microfluidic control apparatus includes a photoconductive material layer and a flow passage.

The microfluidic control apparatus operating method includes steps of: (a) when a light with a specific optical pattern is emitted toward the photoconductive material layer, at least three virtual electrodes being formed on the photoconductive material layer according to the specific optical pattern; (b) when the specific optical pattern changes, the at least three virtual electrodes also changing to generate an electro-osmotic force to control a moving state of a microfluid in the flow passage.

Wherein, the at least three virtual electrodes include a first virtual electrode, a second virtual electrode, and a third virtual electrode; the second virtual electrode and the third virtual electrode are disposed at two sides of the first virtual electrode, and a specific ratio is existed among the distance between the first virtual electrode and the third virtual electrode, the width of the first virtual electrode, the distance between the first virtual electrode and the second virtual electrode, and the width of the second virtual electrode.

In practical applications, the specific ratio existed among the distance G1 between the first virtual electrode and the third virtual electrode, the width W1 of the first virtual electrode, the distance G2 between the first virtual electrode and the second virtual electrode, and the width W2 of the second virtual electrode can be 1:5:1:3. The photoconductive material layer can be formed by a material having resistance varied with different lights; the photoconductive material layer can be charge generating layer material Titanium Oxide Phthalocyanine (TiOPc), amorphous silicon (a-Si), or polymer.

In this embodiment, an Electro-Osmotic Flow (EOF) mechanism can be used to change the position of the specific optical pattern to adjust a forming ratio of the at least three virtual electrodes formed on the photoconductive material layer to control the microfluid. Under the condition of maintaining the voltage and the frequency unchanged, the microfluidic control apparatus controls a moving direction or a rotation direction of the particles in the microfluid, so that the microfluid forms moving states of driving, mixing, concentrating, separating, and swirl.

Compared to the Electro-Osmotic Flow (EOF) mechanism used in conventional microfluidic control apparatus of the prior arts, the microfluidic control apparatus of the invention uses the Opto-Electro-Osmotic Flow (OEOF) mechanism without changing the voltage and the frequency to change the position of the optical pattern to adjust the alignment and forming ratio of virtual electrodes formed on the photoconductive material layer to control the various moving states of the microfluid.

By doing so, the microfluidic control apparatus and operating method thereof in the invention can effectively increase the convenience and flexibility of controlling the microfluid without changing the positions of electrodes of various sizes or continuously changing the applied voltage and its frequency. Therefore, the microfluidic control apparatus and operating method thereof in the invention can be widely applied in various microfluid systems, such as medical chips, drug reagents mixing, cells or small particles control, and have great market potential and future development.

The advantage and spirit of the invention may be understood by the following detailed descriptions together with the appended drawings.

BRIEF DESCRIPTION OF THE APPENDED DRAWINGS

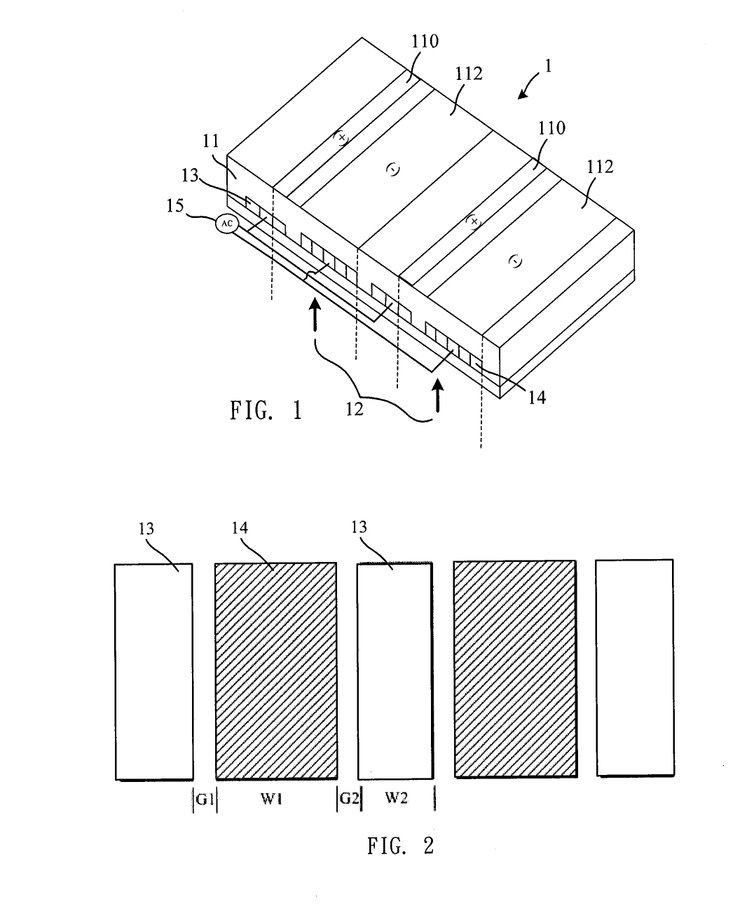

FIG. 1 illustrates a schematic figure of the microfluidic control apparatus in the first embodiment of the invention.

FIG. 2 illustrates the ratio relationship of the distance and width of the ITO electrodes 13 and 14.

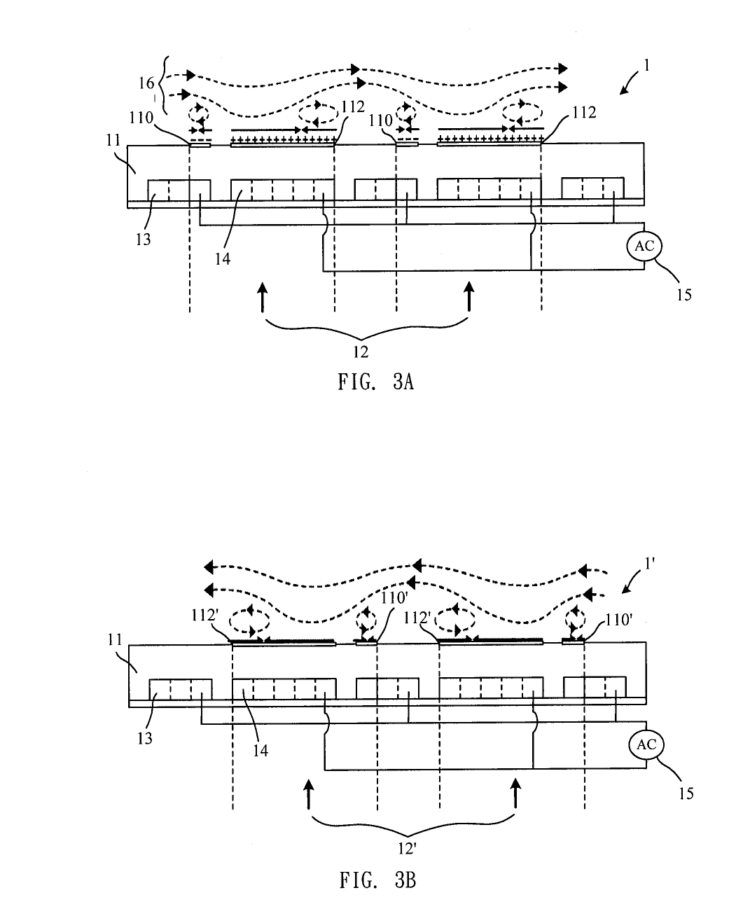

FIG. 3A illustrates a side schematic figure of the light with the specific optical pattern 12 emitting toward the photoconductive material layer 11 of the microfluidic control apparatus 1.

FIG. 3B illustrates a side schematic figure of forming different virtual electrodes on the photoconductive material layer 11 because the specific optical pattern 12 shown in FIG. 3A was moved to the specific optical pattern 12′.

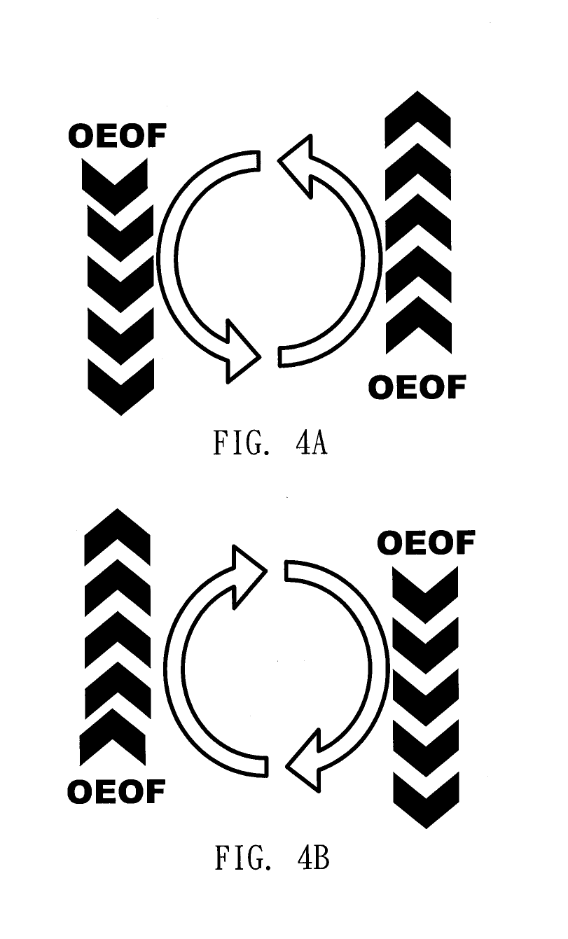

FIG. 4A and FIG. 4B illustrate an embodiment of using the above-mentioned OEOF mechanism to control the moving state of the microfluid.

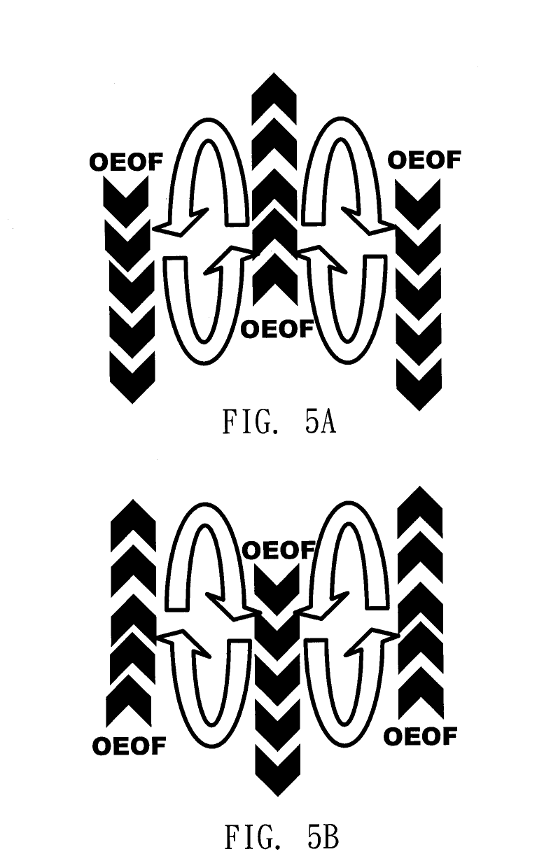

FIG. 5A and FIG. 5B illustrate another embodiment of using the above-mentioned OEOF mechanism to control the moving state of the microfluid.

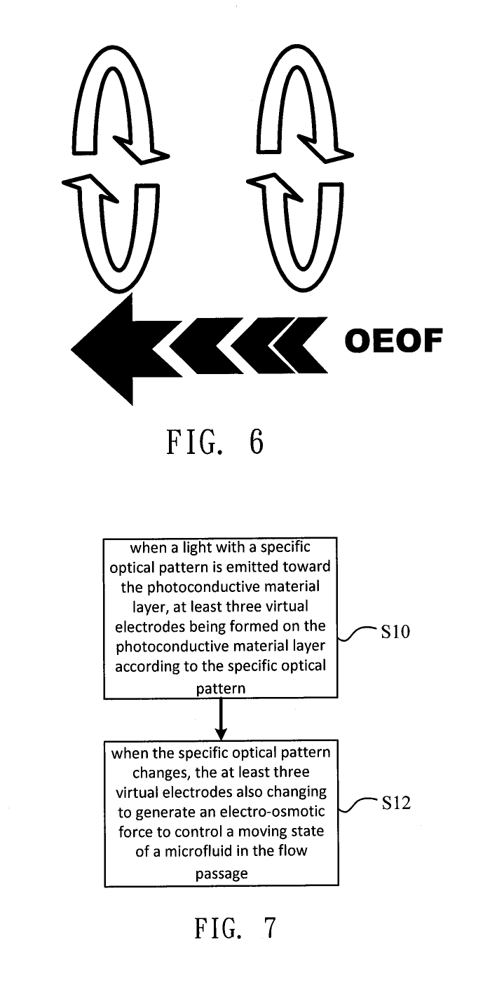

FIG. 6 illustrates an embodiment of using the OEOF mechanism to control the moving state of the microfluid.

FIG. 7 illustrates a flowchart of the microfluidic control apparatus operating method in the second embodiment of the invention.

### DETAILED DESCRIPTION OF THE INVENTION

A first embodiment of the invention is a microfluidic control apparatus. In this embodiment, the microfluidic control apparatus is used to control a moving state of a microfluid. In fact, the microfluid can be any kinds or types of biological samples or chemical samples without any limitations. Please refer to FIG. 1. FIG. 1 illustrates a schematic figure of the microfluidic control apparatus.

As shown in FIG. 1, the microfluidic control apparatus 1 includes a photoconductive material layer 11. In fact, the photoconductive material layer 11 is formed by a material having resistance varied with different lights, such as charge generating layer material Titanium Oxide Phthalocyanine (TiOPc), amorphous silicon (a-Si), or polymer, but not limited to these cases.

In this embodiment, the photoconductive material layer 11 includes a positive electrode and a negative electrode, such as a positive-charged Indium Tin Oxide (ITO) electrode 13 and a negative-charged ITO electrode 14. Wherein, the ITO electrode 13 is coupled to the positive electrode of the AC power source 15, and the ITO electrode 14 is coupled to the negative electrode of the AC power source 15. As shown in FIG. 2, the distance between the ITO electrode 14 and the ITO electrode 13 at one side is G1, the distance between the ITO electrode 14 and the ITO electrode 13 at the other side is G2, the width of the ITO electrode 14 is W1, and the width of the ITO electrode 13 is W2. In fact, G1:W1:G2:W2 can be 1:5:1:3, and the positive electrode and the negative electrode of the photoconductive material layer 11 can be metal electrode, the only difference is that the light will be emitted from the top of the chip, but not limited to this case.

Then, back to FIG. 1, when the light with the specific optical pattern 12 is emitted toward the photoconductive material layer 11, the photoconductive material layer 11 will form a virtual positive electrode 110 and a virtual negative electrode 112 according to the specific optical pattern 12. Wherein, the ratio of the width of the virtual positive electrode 110 and the width of the virtual negative electrode 112 is 1:5, and the ratio of the distance between the virtual negative electrode 112 and the virtual positive electrode 110 at one side and the distance between the virtual negative electrode 112 and the virtual positive electrode 110 at the other side is 1:3.

In practical applications, the light with the specific optical pattern 12 can be emitted from any types of light source emitting apparatuses, such as conventional bulbs, fluorescent lamps, or LEDs, and the number and positions of the light source emitting apparatuses can be adjusted based on practical needs without any specific limitations. In addition, the types of the specific optical pattern can be also determined based on practical needs.

Please refer to FIG. 3A. FIG. 3A illustrates a side schematic figure of the light with the specific optical pattern 12 emitting toward the photoconductive material layer 11 of the microfluidic control apparatus 1. As shown in FIG. 3A, because the virtual positive electrode 110 and the virtual negative electrode 112 are formed on the photoconductive material layer 11 to generate a photoelectric driving effect to make the microfluid in the flow passage 16 above the photoconductive material layer 11 to flow from left to right, and generate a swirling flow rotated in clockwise direction at some locations in the flow passage 16. In practical applications, the photoelectric driving effect can be the electrophoresis (EP) mechanism, the dielectrophoresis (DEP) mechanism, or any other mechanisms of providing electrical field change and/or magnetic field change through electrodes.

The definition of the so-called “EP mechanism” is that the charged particle will move toward the electrode with opposite electricity under the effect of the electrical field. For example, under the effect of the electrical field, the positive charge will move toward the negative electrode and the negative charge will move toward the positive electrode. The definition of the so-called “DEP mechanism” is that the particle will move under the effect of non-uniform electrical field. When the particle is polarized in the non-uniform electrical field, the particle will move toward the direction of strong or weak electrical field due to the asymmetric electrical attraction. In fact, the DEP mechanism can be used to control any charged particle or uncharged particle, such as small substances like the cell, the germ, the protein, the DNA, or the carbon nanotube.

Then, please refer to FIG. 3B. FIG. 3B illustrates a side schematic figure of forming different virtual electrodes on the photoconductive material layer 11 because the specific optical pattern 12 shown in FIG. 3A was moved to the specific optical pattern 12′. As shown in FIG. 3B, since the specific optical pattern 12′ is generated by the rightward movement of the original specific optical pattern 12, the alignment of the virtual electrodes formed on the photoconductive material layer 11 is different from that of FIG. 3A.

At this time, because the alignment of the virtual positive electrode 110′ and the virtual negative electrode 112′ of FIG. 3B is opposite to that of the virtual positive electrode 110 and the virtual negative electrode 112 of FIG. 3A, the microfluid flowed in the flow passage above the photoconductive material layer 11 will be affected by the photoelectric driving effect to flow from right to left, and swirling flowing rotated in the counter-clockwise direction will be generated at some positions. Similarly, the photoelectric driving effect can be the electrophoresis (EP) mechanism, the dielectrophoresis (DEP) mechanism, or any other mechanisms of providing electrical field change and/or magnetic field change through electrodes.

By doing so, the invention can use the OEOF mechanism without changing the voltage and the frequency to change the position of the optical pattern to adjust the forming ratio of the virtual positive electrode and the virtual negative electrode formed on the photoconductive material layer to control the moving direction or rotation direction of the particle of the microfluid to form the various moving states of the microfluid.

Next, various examples using the above-mentioned OEOF mechanism to control the moving states of the microfluid are introduced.

At first, please refer to FIG. 4A and FIG. 4B. FIG. 4A and FIG. 4B illustrate an embodiment of using the above-mentioned OEOF mechanism to control the moving state of the microfluid. In this embodiment, the user can use two OEOFs flowing in opposite directions to form a microfluid swirl. As shown in FIG. 4A, when the user emits a light with a optical pattern to the photoconductive material layer, the left OEOF will flow downward and the right OEOF will flow upward, so that the microfluid between them will generate swirl movement rotating in counter clockwise direction.

When the user changes the location of the optical pattern (e.g., moving toward right), as shown in FIG. 4B, the left OEOF will flow upward and the right OEOF will flow downward, so that the microfluid between them will generate swirl movement rotating in clockwise direction.

Then, please refer to FIG. 5A and FIG. 5B. FIG. 5A and FIG. 5B illustrate another embodiment of using the above-mentioned OEOF mechanism to control the moving state of the microfluid. In this embodiment, the user can use three OEOFs flowing in different directions to form two microfluid swirls.

As shown in FIG. 5A, when the user emits a light with a optical pattern to the photoconductive material layer, the left OEOF and right OEOF will flow downward and the center OEOF will flow upward, so that the microfluid between the left OEOF and the center OEOF will generate swirl movement rotating in counter clockwise direction, and the microfluid between the right OEOF and the center OEOF will generate swirl movement rotating in clockwise direction.

As shown in FIG. 5B, when the user changes the location of the optical pattern, the left OEOF and the right OEOF will flow upward and the center OEOF will flow downward, so that the microfluid between the left OEOF and the center OEOF will generate swirl movement rotating in clockwise direction, and the microfluid between the right OEOF and the center OEOF will generate swirl movement rotating in counter clockwise direction.

FIG. 6 illustrates another embodiment of using the OEOF mechanism to control the moving state of the microfluid. As shown in FIG. 6, because the OEOF at the bottom flows from right to left, the microfluid above the OEOF will be affected to generate swirl movement rotating in clockwise direction.

A second embodiment of the invention is a microfluidic control apparatus operating method. In this embodiment, the microfluidic control apparatus operating method is applied in a microfluidic control apparatus, and the microfluidic control apparatus includes a photoconductive material layer and a flow passage. Please refer to FIG. 7. FIG. 7 illustrates a flowchart of the microfluidic control apparatus operating method.

As shown in FIG. 7, the microfluidic control apparatus operating method includes the following steps. At first, in step S10, when a light with a specific optical pattern is emitted toward the photoconductive material layer, at least three virtual electrodes being formed on the photoconductive material layer according to the specific optical pattern. In practical applications, the light can be emitted from any types of light source emitting apparatuses, such as conventional bulbs, fluorescent lamps, or LEDs, and the number and positions of the light source emitting apparatuses can be adjusted based on practical needs without any specific limitations. In addition, the types of the specific optical pattern can be also determined based on practical needs.

Wherein, the at least three virtual electrodes include a first virtual electrode, a second virtual electrode, and a third virtual electrode; the second virtual electrode and the third virtual electrode are disposed at two sides of the first virtual electrode, and a specific ratio is existed among the distance between the first virtual electrode and the third virtual electrode, the width of the first virtual electrode, the distance between the first virtual electrode and the second virtual electrode, and the width of the second virtual electrode.

In practical applications, the specific ratio existed among the distance G1 between the first virtual electrode and the third virtual electrode, the width W1 of the first virtual electrode, the distance G2 between the first virtual electrode and the second virtual electrode, and the width W2 of the second virtual electrode can be 1:5:1:3. The photoconductive material layer can be formed by a material having resistance varied with different lights; the photoconductive material layer can be charge generating layer material Titanium Oxide Phthalocyanine (TiOPc), amorphous silicon (a-Si), or polymer.

Then, in step S12, when the specific optical pattern changes (e.g., generates a movement), the at least three virtual electrodes also changing to generate an electro-osmotic force to control a moving state of a microfluid in the flow passage. That is to say, the method uses an Electro-Osmotic Flow (EOF) mechanism to change the position of the specific optical pattern to adjust a forming ratio of the at least three virtual electrodes formed on the photoconductive material layer to control the microfluid.

By doing so, under the condition of maintaining the voltage and the frequency unchanged, the microfluidic control apparatus controls a moving direction or a rotation direction of the particles in the microfluid, so that the microfluid forms moving states of driving, mixing, concentrating, separating, and swirl.

Compared to the Electro-Osmotic Flow (EOF) mechanism used in conventional microfluidic control apparatus of the prior arts, the microfluidic control apparatus of the invention uses the Opto-Electro-Osmotic Flow (OEOF) mechanism without changing the voltage and the frequency to change the position of the optical pattern to adjust the alignment and forming ratio of virtual electrodes formed on the photoconductive material layer to control the various moving states of the microfluid.

By doing so, the microfluidic control apparatus and operating method thereof in the invention can effectively increase the convenience and flexibility of controlling the microfluid without changing the positions of electrodes of various sizes or continuously changing the applied voltage and its frequency. Therefore, the microfluidic control apparatus and operating method thereof in the invention can be widely applied in various microfluid systems, such as medical chips, drug reagents mixing, cells or small particles control, and have great market potential and future development.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A microfluidic control apparatus, comprising:
a flow passage; and
a photoconductive material layer, when a light with a specific optical pattern is emitted toward the photoconductive material layer, at least three virtual electrodes being formed on the photoconductive material layer according to the specific optical pattern, wherein the at least three virtual electrodes comprise a first virtual electrode, a second virtual electrode, and a third virtual electrode; the second virtual electrode and the third virtual electrode are disposed at two sides of the first virtual electrode, and a specific ratio is existed among the distance between the first virtual electrode and the third virtual electrode, the width of the first virtual electrode, the distance between the first virtual electrode and the second virtual electrode, and the width of the second virtual electrode;
wherein when the specific optical pattern changes, the at least three virtual electrodes also change to generate an electro-osmotic force to control a moving state of a microfluid in the flow passage.

2. The microfluidic control apparatus of claim 1, wherein an Electro-Osmotic Flow (EOF) mechanism is used to change the position of the specific optical pattern to adjust a forming ratio of the at least three virtual electrodes formed on the photoconductive material layer to control the microfluid.

3. The microfluidic control apparatus of claim 1, wherein the specific ratio existed among the distance G1 between the first virtual electrode and the third virtual electrode, the width W1 of the first virtual electrode, the distance G2 between the first virtual electrode and the second virtual electrode, and the width W2 of the second virtual electrode is 1:5:1:3.

4. The microfluidic control apparatus of claim 1, wherein under the condition of maintaining the voltage and the frequency unchanged, the microfluidic control apparatus controls a moving direction or a rotation direction of the particles in the microfluid, so that the microfluid forms moving states of driving, mixing, concentrating, separating, and swirl.

5. The microfluidic control apparatus of claim 1, wherein the photoconductive material layer is formed by a material having resistance varied with different lights, the photoconductive material layer is charge generating layer material Titanium Oxide Phthalocyanine (TiOPc), amorphous silicon (a-Si), or polymer.

6. A microfluidic control apparatus operating method applied in a microfluidic control apparatus, the microfluidic control apparatus comprising a flow passage and a photoconductive material layer, the method microfluidic control apparatus operating comprising steps of:
(a) when a light with a specific optical pattern is emitted toward the photoconductive material layer, at least three virtual electrodes being formed on the photoconductive material layer according to the specific optical pattern; and
(b) when the specific optical pattern changes, the at least three virtual electrodes also changing to generate an electro-osmotic force to control a moving state of a microfluid in the flow passage;
wherein, the at least three virtual electrodes comprise a first virtual electrode, a second virtual electrode, and a third virtual electrode; the second virtual electrode and the third virtual electrode are disposed at two sides of the first virtual electrode, and a specific ratio is existed among the distance between the first virtual electrode and the third virtual electrode, the width of the first virtual electrode, the distance between the first virtual electrode and the second virtual electrode, and the width of the second virtual electrode.

7. The microfluidic control apparatus operating method of claim 6, wherein an Electro-Osmotic Flow (EOF) mechanism is used to change the position of the specific optical pattern to adjust a forming ratio of the at least three virtual electrodes formed on the photoconductive material layer to control the microfluid.

8. The microfluidic control apparatus operating method of claim 6, wherein the specific ratio existed among the distance G1 between the first virtual electrode and the third virtual electrode, the width W1 of the first virtual electrode, the distance G2 between the first virtual electrode and the second virtual electrode, and the width W2 of the second virtual electrode is 1:5:1:3.

9. The microfluidic control apparatus operating method of claim 6, wherein under the condition of maintaining the voltage and the frequency unchanged, the microfluidic control apparatus controls a moving direction or a rotation direction of the particles in the microfluid, so that the microfluid forms moving states of driving, mixing, concentrating, separating, and swirl.

10. The microfluidic control apparatus operating method of claim 6, wherein the photoconductive material layer is formed by a material having resistance varied with different lights, the photoconductive material layer is charge generating layer material Titanium Oxide Phthalocyanine (TiOPc), amorphous silicon (a-Si), or polymer.
